(19) United States
(12) Patent Application Publication
(10) Pub. No.: US 2012/0279519 A1
(43) Pub. Date: Nov. 8, 2012

(54) Integrated Substrate Cleaning System and Method

(75) Inventors: Gordon Scott Swanson, Livermore, CA (US); Ivin Varghese, Livermore, CA (US); Mehdi Balooch, Berkeley, CA (US)

(73) Assignee: RAVE N.P., INC., Delray Beach, FL (US)

(21) Appl. No.: 13/284,078

(22) Filed: Oct. 28, 2011

Related U.S. Application Data
(60) Provisional application No. 61/407,852, filed on Oct. 28, 2010.

(51) Int. Cl. B08B 7/00; B08B 13/00

(52) U.S. Cl. 134/1.1; 156/345.43

(57) ABSTRACT

A method for cleaning a substrate having organic and inorganic residues disposed thereon is provided. The method includes removing organic residue from the substrate using atmospheric oxygen plasma, and removing inorganic residue from the substrate using cryogenic CO₂. The substrate may be pretreated using a benign cooling agent, and post-treated using a dilute wet chemical cleaning method.

### CROSS-REFERENCE TO RELATED APPLICATIONS

This application claims priority to U.S. Provisional Patent Application Ser. No. 61/407,852, filed on Oct. 28, 2010, the disclosure of which is incorporated herein by reference in its entirety.

### FIELD OF THE INVENTION

The present invention relates to substrate cleaning processes. More particularly, the present invention relates to an integrated system and method for cleaning a substrate.

### BACKGROUND OF THE INVENTION

The field of particle, residue removal and surface cleaning in general extends far beyond the semiconductor industry. Many applications in biological, medical (implants and equipment), aerospace, imaging, automotive, pharmaceutical, etc. extensively use surface cleaning as a preparation step for post or preprocessing. The need for scrupulously clean wafers in the fabrication of microelectronic devices has been well recognized since the dawn of solid-state device technology. As semiconductor device geometry continues to shrink, and wafer sizes increase, the limitations of existing cleaning methods on devices yield will become more critical as the size of “killer” particles also shrinks. In nanoscale manufacturing that need is increased by more than one order of magnitude. A benign, substrate independent, cleaning process is highly desirable since it does not have to be modified for different substrates (as in a chemical based cleaning process) and it does not have a potential for modifying the surface (such as etching, roughening, etc.).

Traditionally there are several particle and residual removal techniques used in semiconductor fabrication and other industries affected by surface contamination. They include ultrasonic, megasonics, brush scrubbing, dry Argon ice cleaning, plasma etching, or wet etching, etc. Effective dry cleaning techniques have been sought after methods in the industry for the past decade. One dry cleaning techniques that is film independent is aerosol jets cleaning has been shown to have a good potential for dry removal of submicron particles. Particles in the gas stream can be formed by the solidification of liquid droplets or the gaseous medium during rapid cooling. When the solid particle collides with the particle, the collision energy may overcome the adhesion force and remove the particle or residue from the surface. The CO₂ aerosol cleaning technique has been utilized for a wide variety of surface cleaning applications such as Si wafer, photomask, MEMS devices, packaging fabrication, imaging devices, metal lift-off, ion implanted photoresist stripping, disk drives, flat panel displays, and post-dicing for 3-D stacked IC integration flows.

In the mask industry, the top critical issues are the cost and cycle time of mask technology and mask supply. There are numerous yield loss mechanisms for mask technology: excessive quantity of lithography defects, un-repairable defects, particle defects, and particle defects after pellicle mounting. The pellicle is mounted on lithography photomasks using an adhesive to protect the active area of the mask from any defects. These masks are utilized to repeatedly print fine features on masks for high volume products. Mask lifetime is reduced due to issues like growth of organic layer of defects (also called haze), electro-static discharge (ESD), non-removable particles, transmission loss, reflectivity loss, phase change, change in printed critical dimensions (CD) uniformity, etc. Conventional solvent cleaning techniques result in degradation of the mask, and hence reduce the mask lifetime. There is a very tight specification on the mask properties that need to be maintained for its usage. Foreign material and stains are known as soft defects on masks that require cleaning. Defects that are found on masks are not what matters but their printability. Defects flagged by the inspection tool may not print, or observed defects may not be electrically pertinent to an active circuit. The concern is some defects may print due to the particular illumination or focus condition, but may not be observed during the mask inspection.

There is a necessity for mask incoming inspection and re-qualification, due to the repeated printing of defects due to processing defects of the original mask or degrading defects on the mask during fab usage (i.e. haze, ESD, and moving particles, etc.). Thus, due to a multitude of issues, at times, the pellicle needs to be removed from the mask to implement repairs and cleaning to eliminate the defects that have resulted in wafer printing errors. Once the pellicle has been removed, some pellicle adhesive residue is generally remnant. This residue needs to be completely removed before a new pellicle can be put in place, once the printing area defects have been eliminated. There are several pellicle-related issues that also results in mask maintenance service required like: damaged pellicle, particles under the pellicle, lithography light exposure-induced degradation, non-removable particles, etc. UV and EUV exposure-induced degradation of the pellicle glue after a large number of exposures results in a more stubborn residue after the pellicle is removed. The ultimate goal is to have a cleaning technique that will, in a damage-free manner, remove all pellicle glue residue as well as all soft defects that could be both organic as well as in-organic particles.

Known cleaning methods are typically based on wet cleaning that could result in chemical attack to structures (or in some cases the utilized chemicals lead to additional problems such as deposit of sulfate residues of the sulfuric acid, which is well known as one source for Haze) or dry cleaning mostly with cryogenic CO₂, based on the physical method of momentum transfer, most suitable for inorganic loosely bonded to substrate, or separately dry cleaning with low-pressure plasma dry clean that involves active gas-solid chemistry to remove organic residues (which conventionally performed in reduced atmosphere sometimes called “ashing”).

There are clear advantages to integrating dry cleaning methods that provide chemistry to remove organic as well as inorganic particles or residues effectively. This would be particularly advantageous if done at near atmospheric pressures, thereby avoiding complicated and expensive vacuum technology. Combining methods will thus enable removal of all possible defects in one unit, fast and economically attractive. One important example would be an application common to the photomask industry.

Accordingly, an integrated cleaning technique that combines atmospheric plasma with cryogenic CO₂ is desired.

### SUMMARY OF THE INVENTION

Embodiments of the present invention advantageously provide systems and methods for cleaning a substrate having organic and inorganic residues disposed thereon. In one embodiment, the method includes removing organic residue from the substrate using atmospheric oxygen plasma, and removing inorganic residue from the substrate using cryogenic CO₂. In another embodiment, the system includes a substrate conveyor, an atmospheric oxygen plasma jet apparatus including concentric, inner and outer electrodes through which a mixture of helium and other gases flow in the presence of a voltage field, and a cryogenic CO₂ apparatus.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic of the atmospheric-pressure plasma jet apparatus, according to an embodiment of the present invention.

FIG. 2 is a cross sectional acrylic adhesive film thickness variation on SiO₂ as measured with atomic force microscopy (AFM).

FIG. 3 is an optical image of adhesive film after exposure to oxygen plasma.

FIG. 4 depicts residues of adhesive left after exposure to oxygen plasma.

FIG. 5 presents a combination of local atmospheric plasma and CO₂ clean sources, according to an embodiment of the present invention.

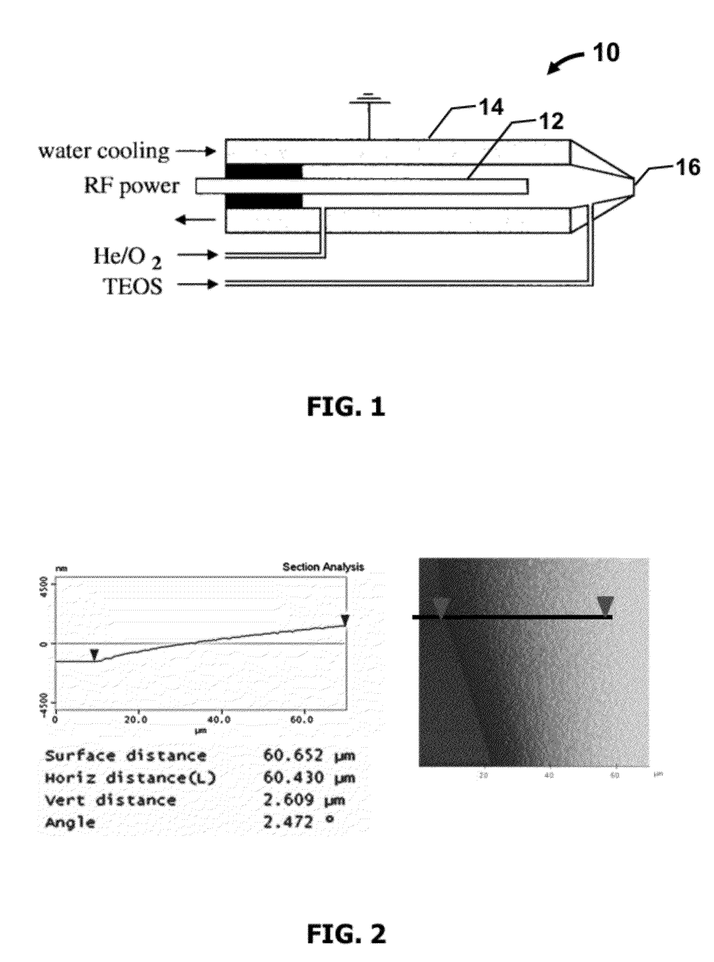

### DETAILED DESCRIPTION

The invention will now be described with reference to the drawing figures, in which like reference numerals refer to like parts throughout.

Embodiments of the present invention advantageously remove localized organic residue, such as, for example, glue, etc., by atmospheric oxygen plasma jet apparatus (oxygen plasma) without using reduced pressure that requires expensive vacuum equipment. In some embodiments, a coolant (e.g. Liquid N₂) shower or spray pre-treatment, for cooling the residue, may be applied before cleaning.

The present invention provides various combinations of cleaning methods, including combining atmospheric oxygen plasma removal with CO₂ cleaning for complete removal of residues, combining submerging the substrate to be cleaned in benign cooling agents, such as liquid N₂ as a pre-treatment, with atmospheric plasma cleaning for complete removal of residues, combining submerging a substrate in benign cooling agents, such as liquid N₂ pre-treatment, with CO₂ cleaning for complete removal of residues, combining submerging a substrate in benign cooling agents, such as liquid N₂ pre-treatment, with atmospheric plasma cleaning followed by CO₂ cleaning for complete removal of residues, combining atmospheric oxygen plasma removal with wet solution chemistry cleaning, in order to reduce the exposure (or process time) and/or milder etchant to minimize damage to active structures, combining submerging a substrate in benign cooling agents, such as liquid N₂ pre-treatment, with CO₂ cleaning and followed with dilute chemistry cleaning for complete removal of residues, combining submerging a substrate in benign cooling agents, such as liquid N₂ pre-treatment, with dilute chemistry cleaning for complete removal of residues, combining submerging a substrate in benign cooling agents, such as liquid N₂ pre-treatment, with CO₂ cleaning and with dilute chemistry cleaning for complete removal of residues, combining submerging a substrate in benign cooling agents, such as liquid N₂ pre-treatment, with atmospheric plasma followed with dilute chemistry cleaning for complete removal of residues, combining atmospheric plasma cleaning with a CO₂ cleaning and followed with dilute chemistry cleaning for complete removal of residues, combining CO₂ cleaning with organic solvent addition, mask heating, LN₂ spray or atmospheric plasma cleaning; other combinations and permutations of these cleaning methods are also contemplated by present invention.

These inventive cleaning combinations provide many advantages over known substrate cleaning methods. For example, no degradation of the substrate, such as a mask, is expected during an integrated plasma plus CO₂ cleaning for removal of organic residues, such as pellicle glue or other contaminates. For CO₂ only cleaning, stubborn residue generally requires copious amounts of CO₂ as well as a very long process time (>1 hr). By pre-application of local atmospheric plasma, the CO₂ consumption can be minimized and the process time can be drastically reduced, which advantageously reduces cost of ownership (CoO).

Using these inventive integrated cleaning methods, stubborn residue that would require a very aggressive wet clean recipe (using up most of the degradation budget that is available for the mask) is either completely preserved or minimized. A reduced chemistry (mild) wet clean may be used in conjunction if there is any residue after these integrated techniques.

In one embodiment, removal of adhesive residue using “dry” cleaning methods can be automated, which has obvious advantages compared to “wet” chemistry that can un-intentionally attack substrate areas that are sensitive to aggressive cleaning agents.

Initial cleaning with oxygen plasma includes exposing the glue area to a local atmospheric plasma jet. The jet apparatus 10 includes two concentric electrodes, inner electrode 12 and outer electrode 14, through which a mixture of helium and other gases flow. Applying 13.56 MHz RF power to the inner electrode 12 at a voltage between 100-250 V, ignites a gas discharge and plasma is generated.

The ionized gas from the plasma jet exits through nozzle 16, where it is directed onto a substrate a few millimeters downstream. Under typical operating conditions, the gas velocity is about 10 m/s with the effluent temperature near 150 C. While one known process measures the ozone concentration in the effluent of the plasma jet at different distances from the nozzle and found that it varied from 2−5×10¹⁵ cm⁻³, the present invention develops an O atom concentration that equals 8×10¹⁵ cm⁻³ at the nozzle exit, which gradually falls two orders of magnitude over a 10-cm distance downstream. The concentration of metastable oxygen is about 2×10¹³ cm⁻³ at the exit of the nozzle, which increases to a maximum at 25 mm, and slowly drops off. The O atoms, and possibly the metastable O₂, may be the active species in polyimide etching. Assuming atomic oxygen concentration ˜10¹⁵ cm⁻³, and flow velocity of 10 m/s as estimated above, flux of atomic oxygen on the sample could reach as high as 1×10¹⁸ atoms/cm²−s. If the reaction probability is assumed to be as low as 1%, the rate of glue residue removal will be at least 1×10¹⁶/10¹⁴=10² layers/s or ˜2 μm/minute.

The rate of oxygen removal of acyclic adhesive by locally depositing on an Si wafer covered with 3000 A SiO₂ film has been determined. The film thickness was estimated by atomic force microscopy (AFM) to be at least 2.6 μm. FIG. 2 shows the cross sectional the film variation.

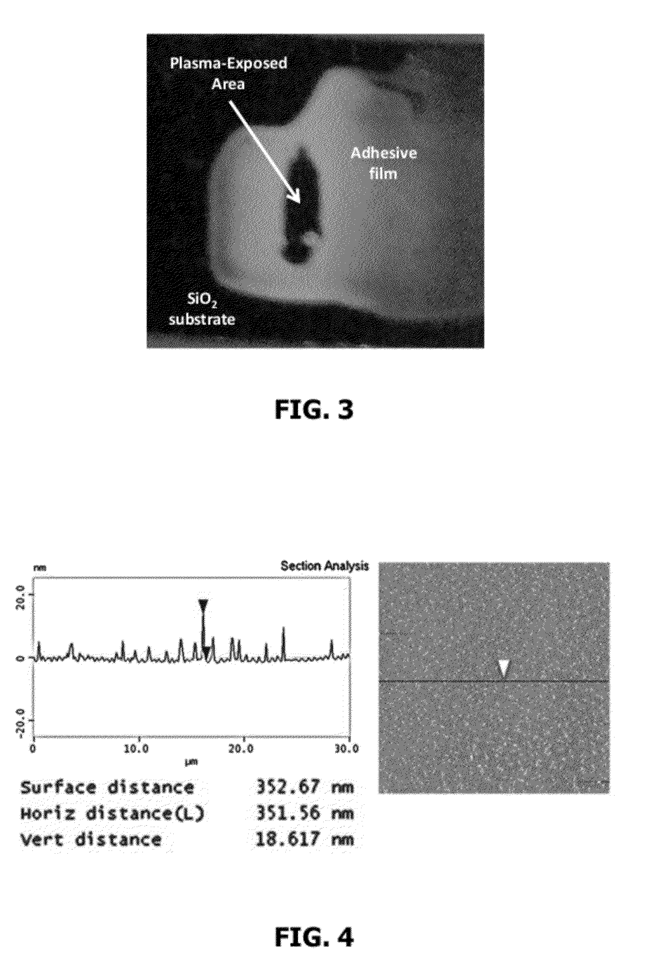

FIG. 3 presents an optical image of the acrylic adhesive film exposed to atmospheric pressure plasma for 40 sec. Visually, the inner oval area that was exposed to oxygen plasma shows effective adhesive removal.

Detailed examination of the exposed area with AFM reveals the existence of patches of glue resides with heights of up to few nanometers (FIG. 4).

In the mask industry, residues of these magnitudes may be tolerated as may not interfere with re-gluing the pellicle on the same area. However, these residues can be easily removed with either a rapid exposure to conventional wet chemistry or preferably by dry physical techniques, such as CO₂ aerosol methods.

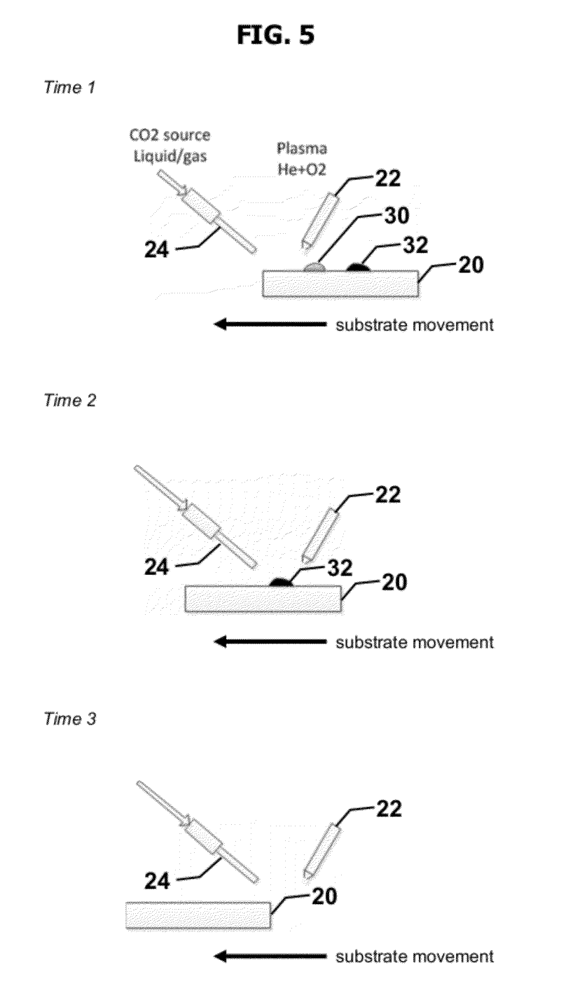

One embodiment of a combined plasma/CO₂ cleaning method is shown schematically in FIG. 5. The substrate 20 moves to left while the plasma cleaning source 22 and the CO₂ cleaning source 24 remain stationary. Alternatively, the substrate 20 may remain stationary while the cleaning sources 22, 24 are moved to right. The plasma cleaning source 22 removes or loosens organic residue 30, followed by the beam from the CO₂ cleaning source 24, which removes loosened organic residue 30 and/or inorganic residue 32.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A method for cleaning a substrate having organic and inorganic residues disposed thereon, comprising:
removing organic residue from the substrate using atmospheric oxygen plasma; and
removing inorganic residue from the substrate using cryogenic CO₂.

2. The method according to claim 1, further comprising pre-treating the substrate using a benign cooling agent.

3. The method according to claim 2, wherein the benign cooling agent is liquid N₂.

4. The method according to claim 2, wherein the pretreating includes submerging the substrate in the cooling agent.

5. The method according to claim 1, further comprising post-treating the substrate using dilute wet chemistry cleaning.

6. The method according to claim 1, wherein the atmospheric oxygen plasma is produced by a jet apparatus that includes concentric, inner and outer electrodes through which a mixture of helium and other gases flow in the presence of a voltage field.

7. The method according to claim 6, wherein radio frequency energy is applied to the inner electrode to generate a voltage between 100 V and 250 V.

8. The method according to claim 6, wherein the gas velocity exiting the jet apparatus is about 10 m/s and the effluent temperature is about 150° C.

9. The method according to claim 6, wherein the jet apparatus generates an atomic oxygen flux of about 1×10¹⁸ atoms/cm²−s.

10. The method according to claim 1, further comprising removing loosened organic residue from the substrate using cryogenic CO₂.

11. A method for cleaning a substrate having organic and inorganic residues disposed thereon, comprising:
pre-treating the substrate using liquid N₂ provided as a shower or a spray;
removing organic residue from the substrate using an atmospheric oxygen plasma jet;
removing organic and inorganic residue from the substrate using cryogenic CO₂; and
post-treating the substrate using dilute wet chemistry cleaning.

12. A system for cleaning a substrate having organic and inorganic residues disposed thereon, comprising:
a substrate conveyor;
an atmospheric oxygen plasma jet apparatus including concentric, inner and outer electrodes through which a mixture of helium and other gases flow in the presence of a voltage field; and
a cryogenic CO₂ apparatus.
